(19) United States
(12) Patent Application Publication
(10) Pub. No.: US 2013/0118070 A1
(43) Pub. Date: May 16, 2013

(54) MODULAR SYSTEM FOR PLANT GROWTH AND AIR PURIFICATION

(71) Applicant: LIVING SYSTEMS, INC., Houston, TX (US)

(72) Inventor: Federico T. Marquez, Houston, TX (US)

(73) Assignee: LIVING SYSTEMS, INC., Houston, TX (US)

(21) Appl. No.: 13/678,412

(22) Filed: Nov. 15, 2012

Related U.S. Application Data
(60) Provisional application No. 61/560,266, filed on Nov. 15, 2011.

(51) Int. Cl. A01G 9/02

(52) U.S. Cl. CPC A01G 9/02
USPC 47/66.6; 47/66.7

(57) ABSTRACT

A modular system for plants and air purification having a plant module with a containment portion for holding a plant growth medium and a conduit for passage of air therethrough. The modular system also contains an exhaust module having an inlet aperture for receiving air flow from the plant module, an outlet aperture and an air pumping unit arranged to pump air from the inlet aperture to the outlet aperture. The plant module and exhaust module are connectable one with the other, and wherein when connected air flow is permitted between the two units.

### CROSS-REFERENCE TO RELATED APPLICATION

This application claims priority to U.S. provisional patent application 61/560,266 filed November 15, 2011 the entire contents of which are hereby incorporated by reference.

### TECHNICAL FIELD

The present disclosure generally relates to modular system for air purification and growth of plants. The modular system provides for a growth media container and a unit for drawing air from the external environment through the system. A growth media can be provided with sufficient porosity and sized particles for plant acclimation and removal of air contaminants. The system is made up of one or more modules, preferably a plurality modules, which can be connected one with the other to form expanded systems. The interconnectability of the modules thereby provides flexibility for multiple environments, including small or large walls, small or large rooms, as well as indoor and outdoor systems.

### BACKGROUND

In modern economies there is large growth in the number of people working indoors and in large office buildings. One of the difficulties that has arisen is the quality of air within the office and building environments. In recent years the physiological and psychological benefits of providing plants in such environments has been studied and recognized.

As a result of such recognition, efforts have been made to improve the air quality and office environment. Such efforts include certification systems such as Leadership in Energy and Environmental Design (LEED) which have been developed to improve the indoor air quality (AQ) of buildings and their occupants.

Additionally plant growth units have been developed such as that disclosed in US 2002/0136669. Therein is disclosed an air filter system utilizing a house plant provided in a growth media and a subsurface air withdrawal member positioned below the top surface of the media. A fan unit pulls air from the environment into and through the plant growth medium. As the air is pulled through the growth media, airborne contaminants such as Volatile Organic Compounds (VOC's), pollens and dust and the like are removed.

Unfortunately, despite these efforts, there are still difficulties in improving the office environment, and in particular providing plant systems which can easily and effectively built into home and building environments. Identified by the inventor herein therefore is a need to provide a system to facilitate easy installation, maintenance and a monitor system for improved plant growth and air quality and in a manner which is aesthetically pleasing.

### SUMMARY

In some embodiments, the present disclosure is directed to a modular system for plants and air purification, the system including a plant module. The plant module can comprise a containment portion for holding a plant growth medium, a conduit for passage of air therethrough, and an exhaust module. The exhaust module can comprise an inlet aperture for receiving air flow from the plant module, an outlet aperture, and an air pumping unit arranged to urge air from the inlet aperture to the outlet aperture. The plant module and exhaust module being independent units and connectable one with the other, and wherein when connected air flow is permitted from said conduit of the plant module to said inlet aperture of the exhaust module.

In further aspects, one or more exhaust modules can be connected together.

In further aspects, the exhaust module can be a stand-alone unit.

In further aspects, the exhaust module can have one or more removable panels, wherein the removable panels can be arranged parallel, adjacent or in series of one another.

In further aspects, the removable panels can have one or more connectors for attaching one or more plant modules.

In further aspects, the removable panels can have one or more air inlets and air outlets, wherein the air inlets can receive air that passed through the plant module and wherein the air outlets can deliver air to the exhaust module.

In further aspects, the plant module is connectable with one or more additional plant modules.

In further aspects, the containment portion has a surface containing a plurality of apertures extending to said conduit.

In further aspects, the exhaust module has one or more air pump units, wherein the air pump unit can be a fan.

In further aspects, the air pump unit is contained within a housing.

In further aspects, the air pump units can be positioned at a top surface of the exhaust module.

In further aspects, the exhaust module has a housing and the exit aperture is located on a surface of the housing.

In further aspects, an air channel is provided from the plant modules to the exhaust pumps for passage of exhaust air from the plant modules out of the exhaust module.

In further aspects, the plant module further includes a plant growth media selected from the group consisting of porous soil, clays, perlite, expanded clay, activated carbon, zeolites, pumice, sphagnum moss, synthetic resins for odor removal, ion-exchange resins for contaminants removal and mixtures thereof.

In further aspects, the growth media contains 10% to 100% pumice.

In further aspects, at least 10% by volume of the plant growth medium is made up of particles from 5 mm to 20 mm in diameter.

In further aspects, the modular system further has watering inlets for providing water to the growth medium.

In further aspects, the modular system includes a plurality of modular sets made up of connected plant modules, and each having a moisture sensor and transmitting data from said sensor to a control unit via wire or wireless transmission.

In further aspects, the system is controlled by a control unit based on one or more variables selected from at least one of light levels, moisture levels, airflow, fan integrity and watering.

In further aspects the plant module includes a sensor for detecting a condition variable, the system further comprising a control unit having a processor, the control unit receiving data from the sensor via wired or wireless communication. The control unit can be integrated with the modular system or located externally from the modular system.

In further aspects, the condition variable is growth media moisture level, degree of light, or air flow rate or a mixture thereof.

In further aspects, the control unit provides a notification to a user when a condition variable is outside of a predetermined range.

In further aspects, the control unit automatically adjusts a condition variable in response to a sensor reading of a condition variable outside of a predetermined range.

In further aspects, a user can modify a condition variable by means of said control unit.

In further aspects, the control unit is a desktop computer, laptop or a handheld mobile device.

### BRIEF DESCRIPTION OF THE DRAWINGS

FIG. 1 illustrates one example of a modular system, in accordance with an example implementation of the present technology;

FIG. 2 illustrates one example of a plant module, in accordance with an example implementation of the present technology;

FIG. 3 illustrates one example of an exhaust module, in accordance with an example implementation of the present technology;

FIG. 4 illustrates another example of an exhaust module, in accordance with an example implementation of the present technology;

FIG. 5 illustrates a cross-sectional view of FIG. 4, in accordance with an example implementation of the present technology;

FIG. 6 illustrates one example of an air flow of a modular system, in accordance with an example implementation of the present technology.

### DETAILED DESCRIPTION

A detailed description of embodiments of the present system, process and apparatus is disclosed herein. However, it is to be understood that the disclosed embodiments are merely exemplary and that there may be multiple embodiments and alternative forms of the present disclosure. Therefore, specific procedural, structural and functional details which are addressed in the embodiments disclosed herein are not to be interpreted as limiting, but merely as a basis for the claims and as a representative basis for teaching one skilled in the art to variously employ the present invention.

Disclosed herein is an air filtration and purification system utilizing house plants in an interconnected modular system. Air is drawn from the external environment into a plant module through a containment portion holding a specialized growth media and passed through an air conduit to a second exhaust module. An air pumping unit is provided in the second module for drawing the air from the plant module passed out of an exhaust outlet aperture.

The plant module can be connected with multiple other plant modules to form a system having any number of plant modules. Additionally, an exhaust module can be connected with any of the plant modules thereby providing the driving force for air flow in the plurality of modules in the system. The modules can be easily installed into a wall indoors of a building or outside. Accordingly, the system is flexible and can be designed for a small wall or easily expanded to fit a much larger surface area. The system can also be attached to existing ventilation system of homes and buildings.

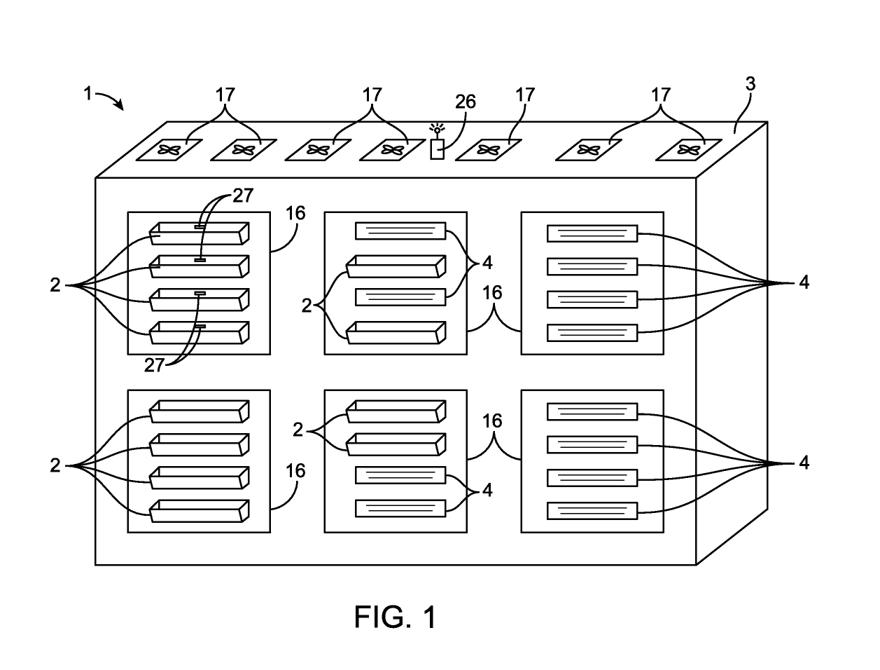

For illustration purposes, a modular system 1 is shown in FIG. 1. In the illustrated embodiment the system is comprised of three primary components, namely a plant module 2, removable panel 16, and an exhaust module 3. Optionally a filler module 4 can be included as well to serve as a water reservoir or to serve other functions. Removable panels 16 can be installed in a plurality of different configurations, for example, in parallel, in series, adjacent to one another, or in any patterns or shapes desired. Removable panels 16 have an air inlet and an air outlet, wherein air inlet and air outlet can create an air channel, where air can travel from the outside environment to the exhaust module. Removable panels 16 can also have one or more plant or filler modules connected to the front face of the panel, wherein the modules can be connected in parallel, in series, adjacent to one another, or in any pattern desired. In another example embodiment, the removable panels 16 are integrated into exhaust module 3 and are static. The one or more sensors 27 can be connected with the control unit 26 via wire connection or wireless. When wires are employed they can be passed through the conduit of the plant module and the exhaust module and passed behind a wall to the control unit. Air pump 17 can be installed on the exhaust module 3. Air pump 17 pulls air through the plant module 2 into the exhaust module 3. The air in this outputted through air pump 17. Modular system 1 can be arranged in a variety of different configurations, suitable for the installed location. For example, Modular system 1 can be configured on the entire wall of a skyscraper lobby or it can be configured on the wall of a single office. System parts can be made of corrosion resistant steel, plastic, or treated metal. In at least one embodiment, plastic and/or steel can be used as plastic and/or steel can be easily fabricated to make interchangeable parts needed.

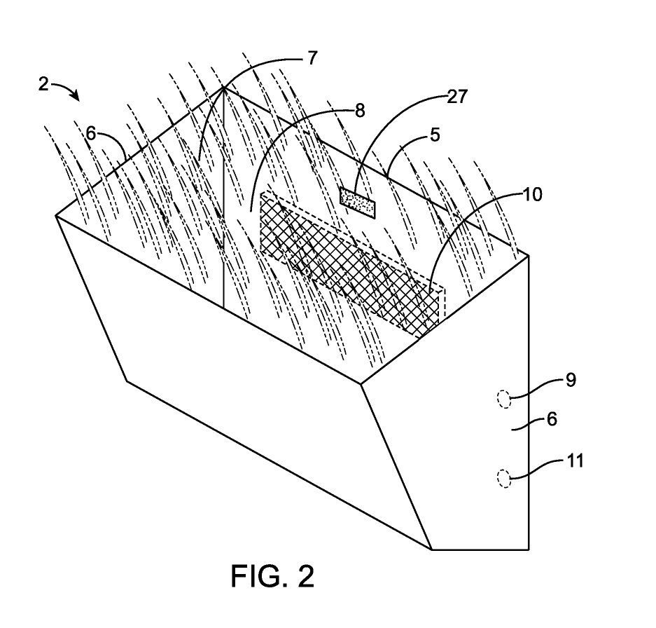

As shown in FIG. 2, the plant module 2 is made up of a housing 5, which is longitudinal and V-shape in form with side walls 6 provided on each end. In other embodiments the plant module 2 can be in a variable of different shapes and designs, for example, cube shaped, rectangular shaped, circular shaped, pyramidal shaped, spherical shaped, any known polygonal shape, or any abstract shape. Accordingly, plant module 2 has a trough, or containment portion 8 within which growth media 7 and plants can be placed. The containment portion should be sized large enough to hold plant pots or the growth media. For example, it can be at least 2 inches, at least 4 inches, 6 inches in depth, or any other depth depending on the size of the pots, plants and amount of growth media used. The growth media can be placed directly in the containment portion and plants grown therein, or the plants can be provided in pots and then placed into the containment portion. Plant module 2 can include a barrier 10, which can prevent growth media 7 from entering exhaust module 3 (shown in FIG. 1). Barrier 10 can comprise a mess, a screen, or any type of semi-permeable material. Plant module 2 can also have a water inlet 9 and a water outlet 11, which can be located on the back wall of housing 5. Water inlet 9 can be located below barrier 10. Water outlet 11 can be located below water inlet 9. Water entering water inlet 9 is gravity feed through growth media 7 and outputted through water outlet 11.

The growth media suitable for use in the presently disclosed modular system includes media which can support the growth of plants as well having sufficient porosity and permeability to permit airflow therethrough. Suitable media include hydroponic media or semi-permeable growth media such as particles of expanded clay, sand, peat, zeolites, fugacites, mulinites, Vermiculite scoria, pumice, perlite soil enhancers such as SoilPro, charcoal, activated carbon, high surface area ion exchange resins, or other aerated soil alone, in combination or in combination with other standard soil compositions. In particular, plants acclimate well with the use of pumice as the growth media. Pumice can make up from 10-100% of the media, alternatively from 30-100%, alternatively from 50-100%, alternatively from 70-100% of the media.

Regardless of the particular media used, the media can be comprised of particles ranging from of 1 mm to 25 mm, 3 mm to 15 mm, and more particularly from 5 mm to 10 mm. Such particles can make up from 10-100% of the media, from 30-100%, from 50-100%, from 70-100% of the media, or any other range of particle sizes that provides optimal acclimation of plants. The media comprised of such sized particles provide optimal acclimation of plants, as well as air flow, and sufficient contact of the air with the media and plants. When particles are too small the media will tend to become too compact, thus interfering with air flow and reducing the degree of air purification and filtration.

Plants suitable for use in the modular system include any plant that will grow in the modular system, in particular standard house plants. Preferred are those with enhanced ability to remove organic contaminants from the air. Houseplants with enhanced contamination removal include: English Ivy (Hedera helix), weeping fig (Ficus benjamina), peace lily (Spathiphyllum sp.), areca palm (Chrysalidocarpus lutescens), Cyclamen (Cyclamen persicum), corn plant (Dracaena fragrans “Massangeana”), lady palm (Rhapis excelsa), Warneckei (Dracaena deremensis “Warneckei”), dumb cane (Dieffenbachia “Exotica compacta”), Ficus alli'(Ficus alli'), dumb cane (Dieffenbachia camille), elephant ear philodendron (Philodendron domesticum), Heart-shape philodendron (Philodendron oxycardium), golden pathos (Epipremnum aureum), Boston Fern (Nephrolepsis exaltata), arrowhead vine (Syngonium podophyllum), snake plant (Sansevieria trifasciata “Laurentii”), Spider Plant (Chlorophytum comosum “Vittatum”), Rubber Plant (Ficus robusta), croton (Codiaeum variegatum) and umbrella grass (Cyperus alternifolius) and other plants known or discovered to have special efficiency for this purpose. Additionally, any plant capable of growing in closed or semi-closed environments will have some beneficial effect.

Most tropical plants sold in nurseries can be beneficially employed. Other wetland plants can also be used although some wetland plants can have extensive root growth and are therefore are not most preferred. Succulents can be used although succulents can have limited microbial activity due to limited root growth.

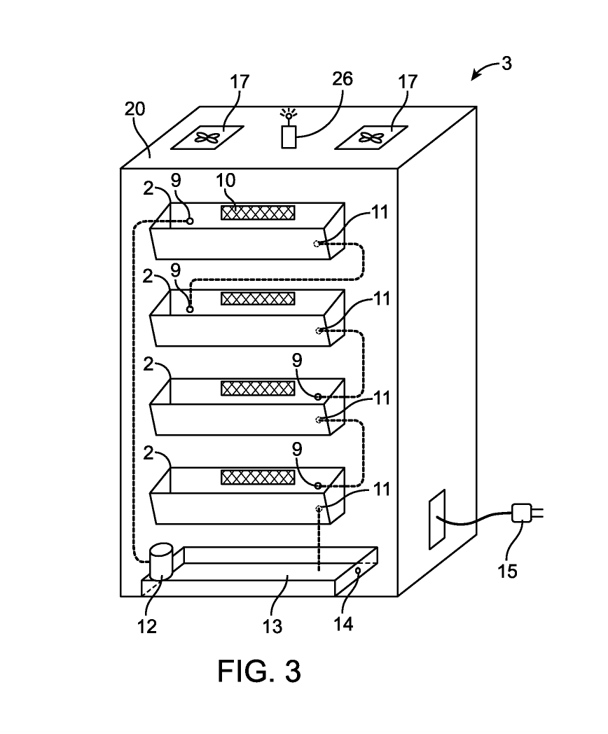

Exhaust module 3 can be a stand-alone unit (as shown in FIG. 3) or one or more exhaust modules can be connected in a plurality of different configurations (as shown in FIG. 1), for example, in parallel, in series, adjacent to one another, or in any patterns or shapes desired. As shown in FIG. 3, the exhaust module 3 is made up of a housing 20. Housing 20 can include air inlets (not shown). Air inlets can be located behind plant module 2 and inline with barrier 10. Submersible pump 12 can pump water from reservoir 13 to water inlet 9 located in the top most plant module 2. Water can be gravity feed from water inlet 9 to water outlet 11 and into the next water inlet 9 located in a plant module 2 below water outlet 11. The water cycle can continue until all remaining water is deposited into reservoir 13. Reservoir 13 can comprise a water line 14, for filling reservoir 13. Reservoir 13 can also include a fill sensor (not shown) to make sure the reservoir is not overfilled. Reservoir 13 can also contain a drain (not shown) to remove water from the reservoir. Power source 15 can be used to supply power to all elements of exhaust module 3. Power source 15 can be any power source, such as AC or DC power source. The power source 15 can employ a battery or plug into any standard 120V or 240V electrical outlet. Of course, preferably, the outlet source in the USA is a 120V outlet, while in other countries, it will generally be a 220V outlet. The DC supply is preferably an 8V to 24V system. Generally a 12V power source can provide enough power to fans, electronics, and related lighting of the system. Exhaust module 3 can also include at least one air pump unit 17 which can be powered by power source 15. The air pump unit 17 can be controlled by a control unit via a wired line or wireless connection. In this way the pumping unit could be turned on or off, or its pumping rate adjusted for desired rate.

The air pump unit 17 can be an air pump, a fan or any device capable of creating air flow. Generally the pumping unit operates by creating a vacuum thus forcing the movement of air. For example, the air pumping unit suitable for use in the modular system includes so-called squirrel cage fans, propeller fans, impeller fans, pumps or any other apparatus that can be used to draw air from a room into a subsurface element and exhausted back into the room. Generally, the fan or circulation device should pull at a rate of between about 1 and 1,000 ft³/min or any other rate which can force the movement of air. As multiple plant modules may be connected together, the pumping unit should be sufficiently powerful drive the airflow through all of the connected modules. An air flow rate of about 20 to 200 cubic feet per minute (CFM) is suitable for most applications.

The pumping unit can include an electric fan, a power supply for supplying electrical power to the fan, an on/off switch for turning the fan on and off and associated electronic circuitry for supporting electric communication between the fan, the power supply and the switch. The unit can further comprise a housing having an intake aperture in fluid communication with the exhaust aperture of the interior and an exhaust aperture in fluid communication with outside air.

The plant module 2 can be connected with the exhaust module 3. As shown in FIG. 3, the back wall of the plant module 2 can be placed and connected to the front wall of the exhaust module 3. The connection between plant module 2 and exhaust module 3 can be made by any known method. For example, hooks, clips, tabs, clamps, screws, pegs, spacer, Velcro, adhesive glue, adhesive tape, latches, any male-female connection methods or any other known method for connecting two objectives vertically.

Upon connection, the modules are arranged such that the barrier 10 aligns with the air inlets (not shown) of the exhaust module. Accordingly, when the air pump unit 17 is activated air is drawn from the external environment through the growth media (as well as any plants growing therein) and passed through the barrier 10 into exhaust module housing 20. The air is then drawn through the housing of exhaust module 3 through the air pump unit 17 and urged out of housing 20 as purified air.

In further embodiments, one or more additional plant modules can be connected to the exhaust module thus forming a plurality of plant modules all connected to the same exhaust module. In this way, any number of plant modules could be placed in series and additionally connected with the exhaust module. The pump unit 17 of the exhaust module should be powerful enough to draw air through each of the modules connected in line. Additionally, multiple exhaust module can be placed in series to aid in promoting air flow through the modules.

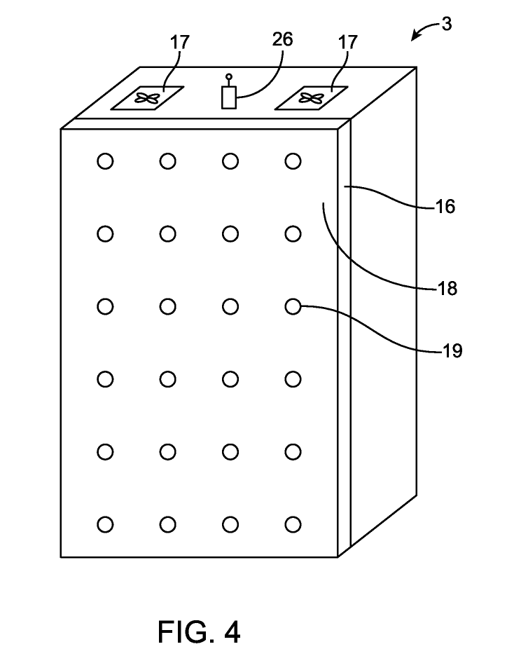

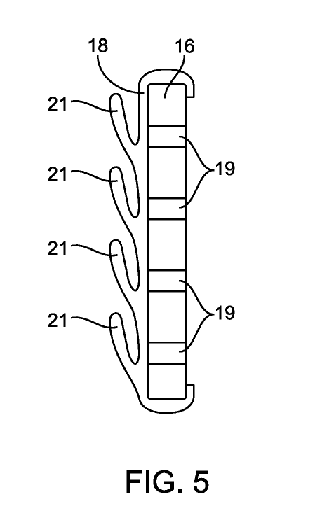

FIG. 4 shows a secondary embodiment of exhaust module 3. The front side of exhaust module 3 can be covered with a felt material 18. Felt material 18 can be wool, cotton, nylon, polyester, plastic blends, 100% recycled PET plastic, or any semi-permeable material. The felt material 18 can wrap around the side of exhaust module 3 and can be attached by any of the previous discussed methods. The felt material can also be attached to a removable panel 16. Removable panel 16 can be attached to exhaust module 3. Exhaust panel 3 and Removable panel 16 can have plurality of air inlets 19. The air inlets 19 can be covered by the felt material 18. Plant module 2 can be connected to the felt material via any of the previously discussed methods. The felt material can also be folded in a manner to create a natural plant module 21 seen in FIG. 5.

FIG. 5 shows a cross-sectional view of a secondary embodiment of exhaust module 3. Felt material 18, covers and wraps around removable panel 16. Folds in felt material 18 create natural plant modules 21, which can align with air inlets 19. Exhaust module 3 and removable panel 16 can be similarly equipped with a water system shown in FIG. 3. Water inlets and outlets can be located on removable panel 16, or directly on exhaust module 3 if a removable panel 16 is not present. Natural plant module 21 can include a growth media to act as a natural air filter. Air located outside of exhaust module 3 can be drawn through the growth media in the natural plant module 21, the air can then be drawn through air inlets 19, into the exhaust module 3 and urged from the air pump units 17 (shown in FIG. 3).

With the flexibility to build the modules into module sets and as many as desired placed on a wall or in a room, it can therefore fit in small or large areas. For example, it may fit on a small surface area of less than 4 ft² and up to surface areas of 100 ft² or more.

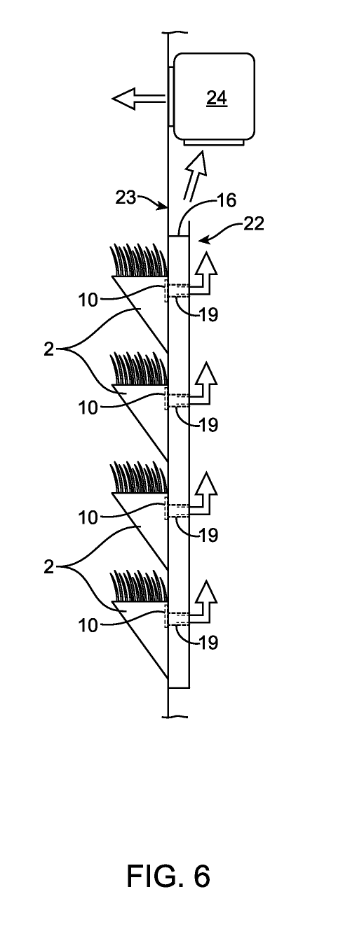

As shown in FIG. 6, a system built on the surface of a wall may after intake of air, exhaust the air to an air plenum 22 behind the wall 23. Accordingly, the multiple plant modules 2 may intake air, exhaust it behind the wall 23 and where the air is either passed to a building HVAC 24 or exhausted out at a system exhaust from the wall. In this way the decontaminated air from all the modules is pooled and directed in a common direction. Removable panel 16 can be installed in wall 23. In another embodiment the multiple plant modules can be installed directly on wall 23 and air inlets 19 can be installed in wall 23. The multiple plant modules can be attached to the removable panel 16 or wall 23 by any of the previously discussed methods.

In the system as shown in FIG. 6, the plant modular pieces can be connected to an existing ventilation system of a home or building and thus would not need air pumping units, but instead can use drawn air from the existing HVAC system. Accordingly, in such embodiments, the exhaust modules can be omitted, or the pumping units in the exhaust modules can be omitted as the driving force for the air flow is the HVAC system.

Airflow is a consideration in the effectiveness and speed of contaminant removal. Generally, the greater the airflow rates through the system, the better the system operates. The modular system allows for ability of several mechanical fans to be used or for a central connection to be used to a more powerful vacuum source (such as a building HVAC).

As shown in FIG. 1, a filler panel 3 can optionally be employed and connected with the exhaust module. The filler panel can be used for a variety of aspects, including acting as a water reservoir, or used to hold a control unit or wireless devices.

The modular system described herein can use manual watering or automatic watering via the filler panel, or a piping or valve in a home or building providing a water source.

This system can be used in an open space as well to remove contaminants in both indoor and outdoor environments. Indoor environments are more effective as there is a limited amount of air volume which can be repeatedly turned over in the system. However, outdoor environments would also benefit if there are any external odors or non-noticeable emissions such as carbon monoxide or carbon dioxide from nearby parking garages or traffic areas.

The modular system disclosed herein also includes a visible and an audible alert system that will notify personnel in immediate vicinity. One or more sensors can be employed in the plant module or exhaust modules to detect the module conditions, such as the moisture content or water level in the growth media, the moisture content of the air, or the amount of light, or air flow. In particular, one or more sensors can be employed for each plant module or for each series of modules connected together. If any of the conditions vary outside of an acceptable range, such as too little water, too much water, too little light, too much light, too high or low air flow, the an audible and/or visible alert can be made as a notification that a variable in the system needs to be corrected. Different notifications can be made for each type of problem, for example, as different light or sound depending on whether the water level is low or the air flow is inadequate.

This disclosure also incorporates a photodiode that is designed to prevent an audible alert if light levels are too low. This prevents alerting building occupants in the middle of the night and thus waking them if system has problems. For example, in one embodiment, the photodiode control will only allow the alert light to flash and allow the system to automatically shut off if problem is severe.

Accordingly, for control of the conditions of the modular system a control unit can be employed. The control unit can be any type of device with a processor, such as a desktop computer, laptop, handheld mobile device or other processing device having proper hardware and software can be employed. The one or more sensors 27 (shown in FIG. 1) can be connected with the control unit 26 via wire connection or wireless. When wires are employed they can be passed through the conduit of the plant module and the exhaust module and passed behind a wall to the control unit.

The one or more sensors can be connected to the control unit to provide data regarding the conditions of the modular system. The control unit can then be used to monitor the conditions of each module as well as the entire system (i.e. all the modules and sets of modules together). Additionally the control unit can issue notifications or alarms to a user if any of the conditions vary outside of acceptable ranges. Additionally, the control unit can be used to vary various condition variables of the process such as air flow rate (e.g. adjusting fan power), watering the growth media, increasing or decreasing lights, as well as other aspects. This can be carried out automatically via by the control unit or manually by the user. Moreover, the sensor data or notifications, or alarms can be provided to a mobile phone such that a user could control the system or any of the modules from a hand held mobile device. Remote monitoring via a camera is also useful with the disclosed modular system, and further such camera may be in communication with the control unit for presentation to a user.

### EXAMPLES

The following is a prophetic example regarding potential outcome for testing the particle size of a growth media, wherein pumice is employed:

TABLE 1
Preferred Growth Medium Sizing for Pumice

| Pumice | | |
|---|---|---|
| particle size | PROS | CONS |
| 1 mm-5 mm | Good filtration; | Dense; may pack over time and |
| | plants acclimate | restrict airflow |
| | well; lightweight | |
| 5 mm-10 mm | Very good filtration; | None identified |
| | plants acclimate | |
| | well; lightweight | |
| 11 mm-15 mm | Good filtration; | Plants do not acclimate as well |
| | does not pack; | and look stressed |
| | lightweight | |
| 15 mm-20 mm | Does not pack; | Plants do not acclimate well; does |
| | lightweight | not provide good filtration |
| >20 mm | Does not pack; | Plants do not acclimate well; does |
| | lightweight | not provide good filtration |

As shown above, it is surprisingly found that particle size has a significant effect on the ability of plants to acclimate. In particular, particle sizes of 5 mm to 10 mm produced the best results with the fewest drawbacks as they allow plants to acclimate well and provide very good filtration.

The following is prophetic example regarding the testing of growth medium:

TABLE 2
Growth Medium

| MEDIUM | Comments |
|---|---|
| Sand | Inexpensive however |
| | Dense, packs too easily |
| | and restricts air flow; |
| | plants do not acclimate |
| | well; not sufficiently |
| | porous |
| Soil | Inexpensive, plants |
| | acclimate well, can be |
| | lightweight; Packs easily |
| | and restricts air flow; can |
| | hold soil borne pathogens; |
| | not porous enough |
| Expanded Clay | Inexpensive; plants can |
| | acclimate over time; does |
| | not pack; It takes time for |
| | plants too acclimate; not |
| | porous enough to provide |
| | good absorbance |
| Zeolite | Inexpensive; Can be made |
| | porous; provides good |
| | absorbance; Dense, packs |
| | too easily and may restrict |
| | air flow; plants do not |
| | acclimate well |
| Vermiculite | Inexpensive; very |
| | lightweight; absorbs |
| | moisture well; Packs too |
| | easily and can drown |
| | roots of plants; plants do |
| | not acclimate well |
| Perlite | Inexpensive; very |
| | lightweight; does not |
| | pack; It takes time for |
| | plants too acclimate; not |
| | porous enough to provide |
| | good absorbance |
| Activated Carbon | Provides very good |
| | absorbance, very porous; |
| | Expensive; plants do not |
| | acclimate well |
| Pumice | Inexpensive; provides |
| | very good absorbance; |
| | lightweight; plants |
| | acclimate well; proper |
| | sizing is preferred for |
| | good bio-filtration and |
| | plant acclimation |

The above shows that many types of growth media may be employed, however, pumice produces the best results when proper particle size is used as shown in Table 1. Furthermore, the above mentioned growth media may be mixed and used in combination.

The following is a prophetic example regarding the ability of certain plants to remove VOC's and also ease of growth.

TABLE 3

| | Removal of | Ease of |
|---|---|---|
| Plants | VOC's | Growth & Care |
| Succulents (ie cacti, aloe, etc.) | Poor | Good |
| Golden Pothos (Epipremnum aureum) | Good | Good |
| English Ivy (Hedera helix) | Good | Good |
| Heart-shape philodendron | Good | Good |
| (Philodendron oxycardium) | | |
| Arrowhead Vine | Good | Good |
| (Syngonium podophyllum) | | |
| Boston Fern (Nephrolepsis exaltata) | Good | Good |
| Cyclamen (Cyclamen persicum) | Good | Good |
| Areca Palm (Chrysalidocarpus lutescens) | Good | Good |
| Peace Lily (Spathiphyllum sp.) | Good | Good |
| Snake Plant (Sansevieria trifasciata) | Good | Good |
| Spider Plant (Chlorophytum comosum | Good | Good |
| “Vittatum” | | |
| Rubber Plant (Ficus robusta) | Good | Good |

What is claimed is:

1. A modular system for plants and air purification comprising:
a plant module comprising
a containment portion for holding a plant growth medium,
a conduit for passage of air therethrough,
an exhaust module comprising
an inlet aperture for receiving air flow from said plant module,
an outlet aperture,
an air pumping unit arranged to urge air from the inlet aperture to the outlet aperture, said plant module and exhaust module being independent units and connectable one with the other, and wherein when connected air flow is permitted from said conduit of the plant module to said inlet aperture of the exhaust module.

2. The modular system of claim 1 wherein said plant module is connectable with one or more additional plant modules.

3. The modular system of claim 1, wherein said containment portion comprises a surface containing a plurality of apertures extending to said conduit.

4. The modular system of claim 1, wherein said air pumping unit is contained within a housing.

5. The modular system of claim 1, wherein the exhaust module has a housing and said exit aperture is located on a surface of the housing.

6. The modular system of claim 1, wherein the plant module further comprises a plant growth media selected from the group consisting of porous soil, clays, perlite, expanded clay, activated carbon, zeolites, pumice, sphagnum moss, and mixtures thereof.

7. The modular system of claim 6, wherein the growth media contains 10% to 100% pumice.

8. The modular system of claim 1, wherein at least 10% by volume of said plant growth medium is made up of particles from 5 mm to 20 mm in diameter.

9. The modular system of claim 1 further comprising watering inlets for providing water to the growth medium.

10. The modular system of claim 1, further comprising a moisture sensor which transmits data via wire or wireless transmission to a control unit.

11. The modular system of claim 10, wherein said sensor measures moisture and light levels.

12. The modular system of claim 11 further comprising a plurality of sets formed of connected plant modules each having a moisture sensor and transmitting data from said sensor to a control unit via wire or wireless transmission.

13. The modular system of claim 1, wherein the system is controlled by a control unit based on one or more variables selected from at least one of light levels, moisture levels, airflow, fan integrity and watering.

14. A process for assembling a modular system comprising:
connecting a plant module with an exhaust module,
said plant module having
a containment portion for holding a plant growth medium, and
a conduit for passage of air therethrough,
said exhaust module having
an inlet aperture for receiving air flow from said plant module,
an outlet aperture, and
an air pumping unit arranged to flow air from the inlet aperture to the outlet aperture,
wherein upon connection air is permitted to flow from said conduit of the plant module to said inlet aperture of the exhaust module.

15. The process of claim 14 further comprising the step of activating said air pumping unit.

16. The modular system of claim 14 wherein said plant module is connectable with one or more additional plant modules.

17. The modular system of claim 14, wherein said containment portion comprises a surface containing a plurality of apertures extending to said conduit.

18. The modular system of claim 14, wherein said air pumping unit is contained within a housing.

19. The modular system of claim 14, wherein the exhaust module has a housing and said exit aperture is located on a surface of the housing.

20. The modular system of claim 14, wherein the plant module further comprises a plant growth media selected from the group consisting of porous soil, clays, perlite, expanded clay, activated carbon, zeolites, pumice, sphagnum moss, synthetic resins for odor removal, ion-exchange resins for contaminants removal and mixtures thereof.

21. The modular system of claim 14, wherein at least 10% by volume of said plant growth medium is made up of particles from 5 mm to 20 mm in diameter.

22. The modular system of claim 21, wherein the growth media contains 10% to 100% pumice.

23. The modular system of claim 14 further comprising watering inlets for providing water to the growth medium.

24. The modular system of claim 14, wherein the moisture sensor transmits data via wire or wireless transmission to a control unit.

25. The modular system of claim 14, wherein said sensor measures moisture and light levels.

26. The modular system of claim 25 further comprising a plurality of connected plant modules each having a moisture sensor and transmitting data to a control unit via wire or wireless transmission.

27. The modular system of claim 14, wherein the system is controlled by a control unit based on one or more variables selected from light levels, moisture levels, airflow, fan integrity and watering.

28. A plant growth and air purification unit comprising,
a housing,
a containment portion for holding a plant growth medium, and
a conduit for passage of air therethrough,
said plant growth medium comprising 10% by volume particles from 5 mm to 20 mm in diameter.

29. The modular system of claim 28, wherein the growth media contains 10% to 100% pumice.

30. The modular system of claim 28, wherein the plant module further comprises a plant growth media selected from the group consisting of porous soil, clays, perlite, expanded clay, activated carbon, zeolites, pumice, sphagnum moss, and mixtures thereof.

31. A modular system for plants and air purification comprising:
a plant module comprising
a containment portion for holding a plant growth medium,
a conduit for passage of air therethrough,
an air pumping unit communicating with said conduit, and
a connecting element for connection to and additional plant module.

32. A modular system of claim 1, wherein said plant module comprises a sensor for detecting a condition variable, said system further comprising a control unit having a processor, said control unit receiving data from said sensor via wired or wireless communication.

33. The modular system of claim 32, wherein said condition variable is growth media moisture level, degree of light, or air flow rate or a mixture thereof.

34. The modular system of claim 32, wherein the control unit provides a notification to a user when a condition variable is outside of a predetermined range.

35. The modular system of claim 32, wherein said control unit automatically adjusts a condition variable in response to a sensor reading of a condition variable outside of a predetermined range.

36. The modular system of claim 32, wherein a user can modify a condition variable by means of said control unit.

37. The modular system of claim 32, wherein said control unit is a desktop computer, laptop or a handheld mobile device.
